(19) United States
(12) Patent Application Publication
(10) Pub. No.: US 2024/0221090 A1
(43) Pub. Date: Jul. 4, 2024

(54) SYSTEM AND METHOD FOR EFFICIENT MOVING

(71) Applicant: KYLE ANTHONY BOND, Manassas Park, VA (US)

(72) Inventor: KYLE ANTHONY BOND, Manassas Park, VA (US)

(21) Appl. No.: 18/092,314

(22) Filed: Dec. 31, 2022

(51) Int. Cl. G06Q 50/00; G06Q 50/16

(52) U.S. Cl. CPC G06Q 50/01; G06Q 50/163

(57) ABSTRACT

The present disclosure relates to a novel system to improve the efficiency of moving. The novel system includes a non-transitory machine readable storage medium containing instructions to cause a machine to retrieve a first mover profile associated with a first mover on a software application platform in response to an indication made on the software application platform that the first mover intends to move residences. The first mover profile may include a first set of moving preferences. The novel system includes a non-transitory machine readable storage medium containing instructions to cause a machine to recommend a service provider having one source attribute based on the first set of preferences and the at least one attribute.

### FIELD

The present disclosure relates to a novel system and method that improves the moving process.

### BACKGROUND

The moving process requires advanced planning. Packing and moving, finding the right moving company, and leaving friends and family behind can severely affect the mover's physical and emotional state. Also, finding new communities and forming new relationships are also challenges when moving.

Therefore, a need exists for a system that improves the moving process for movers and helps integrate them into new communities and social networks. The present disclosure meets this need.

### BRIEF DESCRIPTION OF THE DRAWINGS

To facilitate understanding, identical reference numerals have been used, wherever possible, to designate identical elements that are common to the figures. The drawings are not to scale and the relative dimensions of various elements in the drawings are depicted schematically and not necessarily to scale. The techniques of the present disclosure may readily be understood by considering the following detailed description in conjunction with the accompanying drawings.

FIG. 1 is an example computer network system according to one or more examples of the present disclosure.

FIG. 2 is a block diagram of a data processing system in which illustrative embodiments may be implemented.

FIG. 3 illustrates a software application platform according to one embodiment of the present disclosure.

FIG. 4 illustrates a lead system consistent with one embodiment of the present disclosure.

FIGS. 5-9 illustrate various computing systems according to one embodiment of the present disclosure.

FIG. 10 illustrates a client checklist for purchasing or renting a home according to one embodiment of the present disclosure.

FIG. 11 illustrates a manner for users within a software application platform to make service request according to one embodiment of the present disclosure.

FIG. 12 illustrates a manner of users within a software application platform to send friend requests to other users on the platform according to one embodiment of the present disclosure.

FIG. 13 illustrates a manner of users within a software application platform to create and manage business advertisements according to one embodiment of the present disclosure.

FIG. 14 illustrates a manner for users within a software application platform to track and manage real estate transactions according to one embodiment of the present disclosure.

FIG. 15 illustrates a manner for users within a software application platform to communicate with clients according to one embodiment of the present disclosure.

FIG. 16 illustrates a manner for users within a software application to manage new service requests according to one embodiment of the present disclosure.

FIG. 17 illustrates a user interface for managing present service requests according to one or more embodiments of the present disclosure.

### DETAILED DESCRIPTION

Before the present disclosure is described in detail, it is to be understood that, unless otherwise indicated, this disclosure is not limited to specific procedures or articles, whether described or not. It is further to be understood that the terminology used herein is for the purpose of describing particular embodiments only and is not intended to limit the scope of the present disclosure. It must be noted that as used herein, and in the claims, the singular forms “a,” and “the” include plural referents unless the context clearly dictates otherwise.

Where a range of values is provided, it is understood that each intervening value, to the tenth of the unit of the lower limit unless the context clearly dictates otherwise, between the upper and lower limit of that range, and any other stated or intervening value in that stated range, is encompassed within the disclosure. The upper and lower limits of these smaller ranges may independently be included in the smaller ranges, and are also encompassed within the disclosure, subject to any specifically excluded limit in the stated range. Where the stated range includes one or both of the limits, ranges excluding either or both of those included limits are also included in the disclosure. The term “about” generally refers to ±10% of a stated value.

As will be appreciated by one skilled in the art, the present disclosure may be embodied as a system, method or computer program product. Accordingly, the present disclosure may take the form of an entirely hardware embodiment, a software embodiment (including firmware, resident software, micro-code, etc.) stored in a storage device, or an embodiment combining software and hardware aspects that may all generally be referred to herein as a “circuit,” “module,” or “system.” Furthermore, the present disclosure may take the form of a computer program product embodied in any storage device having computer readable program code embodied in the medium.

Any combination of one or more computer-readable storage device may be utilized. The computer-readable storage device may be, for example but not limited to, an electronic, magnetic, optical, electromagnetic, infrared, or semiconductor system, apparatus, or device. More specific examples (a non-exhaustive list) of the computer-readable storage device may include the following: a portable computer diskette, a hard disk, a random access memory (RAM), a read-only memory (ROM), an erasable programmable read-only memory (EPROM or flash memory), a portable compact disc read-only memory (CDROM), an optical storage device, or a magnetic storage device. processed in a suitable manner, if necessary, and then stored in a computer memory. In the context of this document, a computer-usable or computer-readable medium may be any medium that may contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to wireless, wireline, optical fiber cable, RF, etcetera.

Computer program code for carrying out operations of the present disclosure may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that may direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

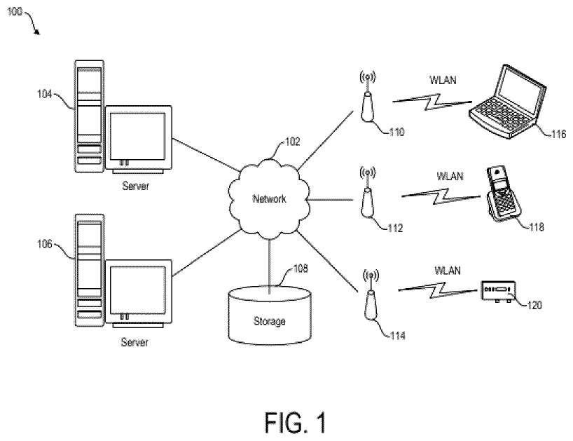

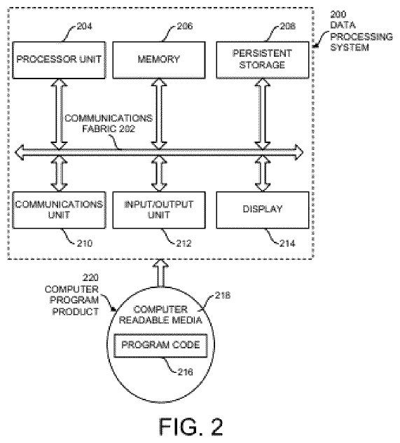

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to data processing environments in which different illustrative embodiments may be implemented. Many modifications to the depicted environments may be made.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims, this term does not foreclose additional structure or steps.

“Configured To.” Various units or components may be described or claimed as “configured to: perform a task or tasks. In such contexts, “configured to” is used to connote structure by indicating that the units/components include structure that performs those task or tasks during operation. As such, the unit/component can be said to be configured to perform the task even when the specified unit/component is not currently operational (e.g., is not on/active). Reciting that a unit/circuit/component is “configured to” perform one or more tasks is expressly intended not to invoke 35 U.S.C. § 112, sixth paragraph, for that unit/component.

“First,” “Second,” etc. As used herein, these terms are used as labels for nouns that they precede, and do not imply any type of ordering (e.g., spatial, temporal, logical, etc.). For example, reference to a “first” pre-defined distance does not necessarily imply that this pre-defined distance is the first pre-defined distance in a sequence; instead, the term “first” is used to differentiate this pre-defined distance from another pre-defined distance (e.g., a “second” pre-defined distance).

Computer network system 100 is a network of data processing systems, such as, for example, computers and other devices, in which the illustrative embodiments may be implemented. One or more client devices employed within computer network system 100 may include a display screen, a plurality of microprocessors, and memory.

Computer network system 100 may include one or more networks which provide communication links between the various computers and other devices connected together within the computer network system 100. In some implementations, network 102 includes connections, such as wire(s), wireless communication links, fiber optic cables, etcetera.

In the example depicted in computer network system 100, servers 104, 106, and storage unit 108 are connected to network 102. Storage unit 108 may be capable of storing data in a structured or unstructured format. Additionally, storage unit 108 may represent a plurality of storage units coupled to network 102. In some implementations of the present disclosure, storage unit 108 may, for example, include any database within an enterprise that stores and manages reusable software assets and any other data related to these reusable software assets. Access Points 110, 112, and 114 may function as a network device that allows client devices to connect to a wired network. However, the present disclosure is not limited thereto. In some implementations, an access point may connect to a router as a standalone device but may also be an integral component of the router itself in some implementations.

In addition, the access points 110, 112, 114 may provide wireless access to client devices 116, 118, 120. Client devices 116, 118, 120 may include personal computers, network computers, laptop computers, hand-held computers, personal digital assistants (PDAs), or smart cellular telephones (e.g., smartphones). It should also be understood by those having ordinary skill in the art that the client devices can be used to access, retrieve, and submit information to the lead generation platform.

In the embodiment shown, client device 116 is a laptop computer, client device 118 is a tablet, and client device 120 is a smartphone device. However, one having ordinary skill in the art should appreciate that the present disclosure is not limited to the specific client devices shown in FIG. 1.

In the implementation shown, access points 110, 112, and 114 are clients to server 104 and/or server 106. In addition, server 104 and/or server 106 may provide data, such as, for example, boot files, operating system images, and applications to access points 110, 112, and 114. Computer network system 100 may include additional servers, clients, and other devices not shown to implement processes of illustrative implementations. In addition, the computer network system 100 includes one or more servers, such as servers 104, 106, which contain mover profiles, mover profile templates, service provider profiles (e.g., realtor historical move data), social network etcetera.

Computer network system 100 may be implemented as a number of different types of networks, such as, for example, an intranet, a local area network (LAN), a wide area network (WAN), and the Internet. It should be noted that FIG. 1 is only intended as an example and not as an architectural limitation for the different illustrative implementations. For example, illustrative implementations may be implemented within a single data processing system or within a computer network system.

In one or more embodiments of the present disclosure, a first mover profile associated with a first mover on a software application platform (not shown) is stored on and retrieved from server 104 and/or server 106 in response to an indication made on the software application platform that the first mover intends to move residences. In some implementations, the first mover profile includes a first set of moving preferences. The software application platform may be accessible by a client device such as smartphone device 120 such that device 120 can send requests for data to the software application platform via a software application downloaded on the device 120. It should be understood by those having ordinary skill in the art that the software application (not shown) that is downloaded on the smartphone device 120 is paired with the software application platform. In addition, the software application platform that is stored on server 104 and/or service 106 can recommend a service provider having a service attribute based on the first set of preferences and the service attribute. The recommended server provider can be accessible by smartphone device 120.

In yet other implementations, the software application platform that is stored on server 104 and/or server 106 can generate a first customized real estate service package for a first mover in response to an indication that the first mover intends to move from a first area to a second area. In some embodiments of the present disclosure, generating the first real estate customized service package includes retrieving a first mover profile associated with the first mover in response to the indication made on the software application platform that the first mover intends to move residentials. The first mover profile may include a first set of moving preferences. The software application platform can recommend a service provider for the first mover based on the first mover's moving preferences and the attributes associated with the available service providers on the software application platform. The recommendation can be retrieved by the smartphone device 120. Messages may be sent to users (e.g., those which have residences in the second area) on the software application platform via smartphone device 120 or other client devices.

In yet other embodiments, a software application platform can host a plurality of mover profiles. Each mover profile may include a first area and the mover profile is associated with a single mover on the software application platform. The movers on the software application platform are members of the same profession or are of the same community. Additionally, in response to an indication that a mover intends to move to a second area, the software application platform can identify which of the other mover's residences are within a pre-defined distance from the second area.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display unit 214.

Processor unit 204 serves to execute instructions for software that may be loaded into memory 206. Processor unit 204 may be a set of one or more processors or may be a multi-processor core, depending on a particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory (RAM) or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208. In addition, persistent storage 208 may represent a plurality of persistent storage units.

Communications unit 210, in these examples, provides for communications with other data processing systems or devices, such as, for example, server 104 or server 106 in FIG. 1. In these examples, communications unit 210 is a network interface card. Communications unit 210 may provide communications through the use of either, or both, physical and wireless communications links.

Input/output unit 212 allows for input and output of data with other devices that may be connected to data processing system 200. For example, input/output unit 212 may provide a connection for user input through a keyboard. Display unit 214 provides a mechanism to display information to a user of data processing system 200.

Instructions for the operating system and applications or programs are located on persistent storage 208. The instructions for the operating system and applications or programs may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different illustrative embodiments may be embodied on different physical or tangible computer-readable media, such as memory 206 or persistent storage 208.

Program code 216 is located in a functional form on computer-readable media 218 and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive or a flash memory that is connected to data processing system 200. The tangible form of computer-readable media 218 is also referred to as computer-recordable storage media.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communication links or wireless transmissions containing the program code.

The different components illustrated for data processing system 200 are not meant to provide architectural limitations to the manner in which different illustrative embodiments may be implemented. The different illustrative embodiments may be implemented in a data processing system including components in addition to, or in place of, those illustrated for data processing system 200. Other components shown in FIG. 2 may be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub, which may be present in communications fabric 202.

There is an opportunity to scale real estate services nationally without the need of investment in physical infrastructure typically required for franchises. The present disclosure facilitates the expansion of real estate services nationally by providing a standardized product.

The present disclosure described herein may be particularly useful for first responders, medical workers, government workers, or service men and women who plan a change of their duty station. Further, the present disclosure may help spouses and other family members find employment and new social communities.

As described herein, the present invention may be implemented as an app-based system such as, but not limited to, a software application platform that enables users find new residences and other related services in an efficient manner. The present disclosure may be particularly useful for users that are highly mobile and move often due to work assignments that require travel. The software application platform described can provide a national referral of clients for businesses.

The present disclosure relates to a novel system to make the moving process more efficient. The novel system includes a non-transitory machine readable storage medium containing instructions to cause a machine to retrieve a first mover profile associated with a first mover on a software application platform in response to an indication made on the software application platform that the first mover intends to move residences. The first mover profile may include a first set of moving preferences. The novel system includes a non-transitory machine readable storage medium containing instructions to cause a machine to recommend a service provider having a source attribute based on the first set of preferences and the attribute.

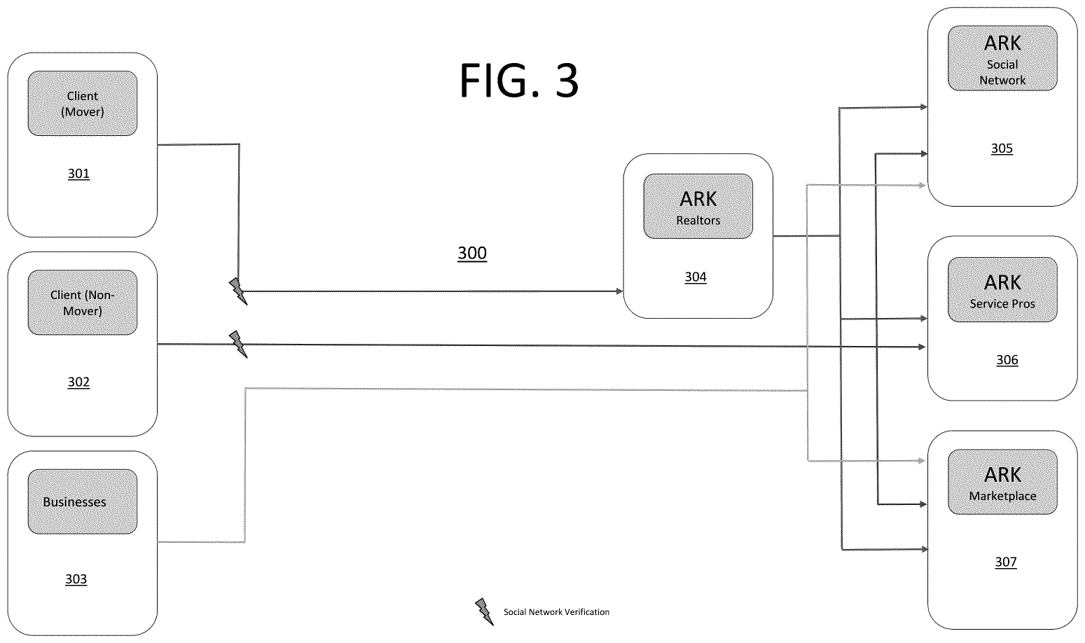

FIG. 3 illustrates a software application platform (e.g., ARK platform 300) according to one embodiment of the present disclosure. The software application platform 300 depicts the interconnection of client leads, service providers, and social network and communities.

Software application platform 300 includes block 301 for newly acquired clients which need, for example, moving services. The software application platform 300 described herein is not limited to client servers that need moving services. As such, block 302 represents clients that do not need moving services. In some embodiments, prospective users that desire to be members on the software application platform 300 are vetted via their social media profiles (e.g., Facebook account).

Block 303 shows that businesses can advertise on the software application platform 300. In one embodiment of the present disclosure, the businesses that are allowed to advertise on the software application platform 300 are those that have user profiles on the software application platform 300. In some implementations, client and business contacts are verified on the software application platform 300 via the user's social media credentials. Software application platform 300 can be integrated with third-party applications to enhance the platform's 300 functionality. Movers may be vetted and the mover's client information can be accessible by realtors on the software application platform 300 (block 304).

Furthermore, service professionals may have user accounts on the software application platform 300 (block 306). The services offered on the platform 300 may be requested by users on the software application platform 300. The service providers may be vetted, according to customer ratings or reviews. If the service providers customer ratings or reviews do not meet a pre-defined standard (e.g., average 5-star review), the service provider can be de-platformed. Lastly, the software application platform 300 may have a marketplace where users can purchase advertisements. As such, users on the software application platform 300 can post goods or services for sale to other users on the platform 300.

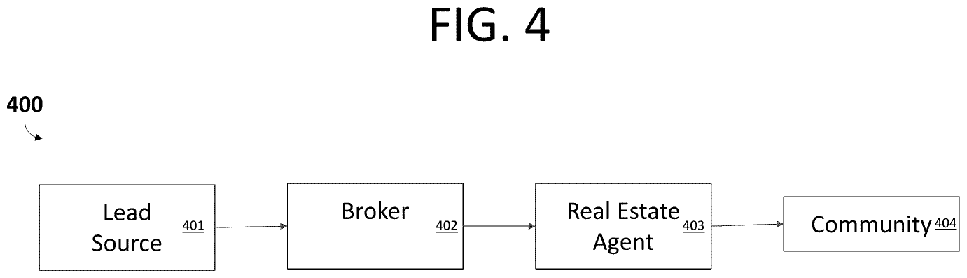

FIG. 4 illustrates a lead system 400 consistent with one embodiment of the present disclosure. The lead system 400 that is shown in FIG. 4 can be implemented in the software application platform to provide client leads for businesses. For example, client leads for real estate professionals to help clients purchase and sell a home. The mover may also be a client lead for a lender. In one embodiment of the present disclosure, the lead system 400 may begin when a user (e.g., mover) signs up and creates a profile on the software application platform. Once the user profile is created, the user may be associated with the lead source phase 401.

The user associated with the new user profile may be forwarded to a broker as shown in broker phase 402. A broker on the software application platform can contact the mover to help them sell or purchase a home. The broker can assign a real estate agent to the mover as shown in agent phase 403 to work directly with the user to sell or purchase a home. The software application platform can integrate users on the platform to social groups and communities based on the user's interests and affiliations as represented by community phase 404.

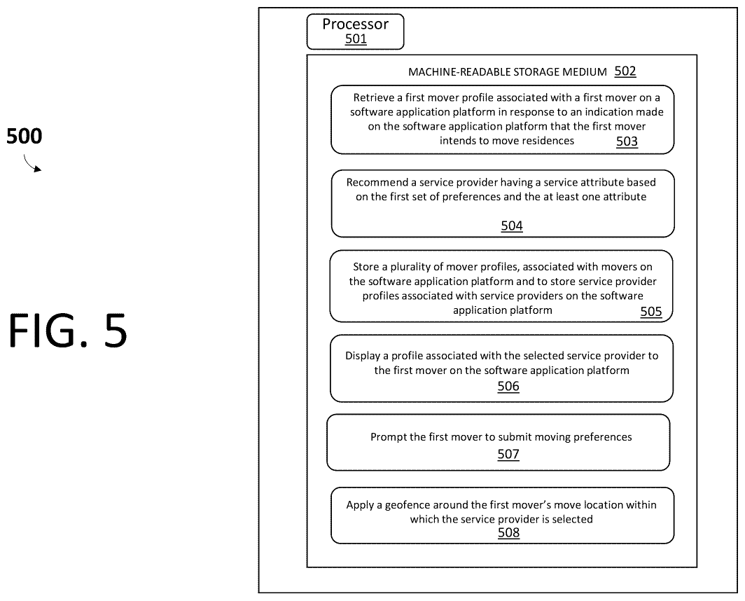

FIG. 5 is an illustration of a computing system 500 according to one or more embodiments of the present disclosure. Computing system 500 may be used by users on the software application platform to receive service recommendations from service providers. The computing system 500 may include a non-transitory computer readable medium 502 that includes computer executable instructions 503-508 stored thereon that, when executed by one or more processing units 501 (one processor shown), causes the one or more processing units 501 to facilitate a moving process.

Computer executable instructions 503 include instructions to retrieve a first mover profile associated with a first mover on a software application platform in response to an indication made on the platform that the first mover intends to move residences. In one embodiment of the present disclosure, the first mover profile includes a first set of moving preferences. Computer executable instructions 504 include instructions to recommend a service provider having a source attribute based on the first set of preferences on the software application platform.

The first mover profile may include the first set of moving preferences based on a second set of moving preferences associated with the first mover during a previous residential move. In some implementations, the first set of preferences may include housing attributes, housing furnishings, neighborhood demographics, school ratings, social events, etcetera.

Further, computer executable instructions 505 include instructions to store mover profiles associated with movers on the software application platform. Computer executable instructions 505 further store service provider profiles associated with service providers on the software application platform. In some implementations, service providers include home service providers, retail service providers, information service providers, and medical service providers. The attributes associated with the service providers may include user ratings and reviews.

Computer executable instructions 506 include instructions to display a profile on the software application platform associated with the selected service provider to the first mover. Further, computer executable instructions 507 include instructions to prompt the first mover to submit moving preferences. Lastly, computer executable instructions 508 include instructions to apply a geofence around the first mover's move location within which the service provider is selected.

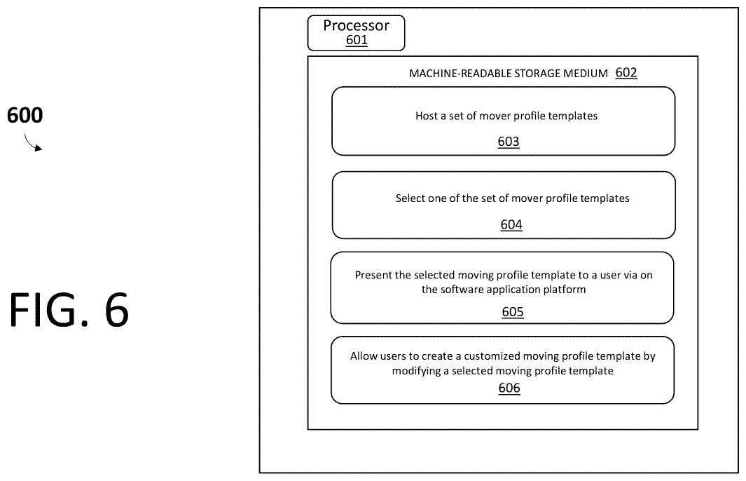

FIG. 6 is an illustration of a computing system 600 according to one embodiment of the present disclosure. Computing system 600 may be used to present mover profile templates to users. The computing system 600 may include a non-transitory computer readable medium 602 that includes computer executable instructions 603-606 stored thereon that, when executed by one or more processing units 601 (one processor shown), causes the one or more processing units 601 to facilitate a moving process.

Computer executable instructions 603 include instructions to host a set of mover profile templates. In one embodiment of the present disclosure, each mover profile includes the mover's moving preferences, preferred service providers, and the user's social networks. The set of mover profile templates are tailored to movers with a particular family profile, moving location, and marital status.

Computer executable instructions 604 include instructions to select one of the set of mover profile templates. A mover profile template may be selected based on a mover's profile and moving preferences. In some other embodiments of the present disclosure, the most popular moving template on the software application platform is selected automatically and assigned to new users.

Computer executable instructions 605 include instructions to present the selected moving profile template to a user on the software application platform. In some implementations, several moving templates may be selected and presented to a mover on the software application platform. Computer executable instructions 606 include instructions to allow users to create a customized moving profile template by modifying a pre-existing moving profile template.

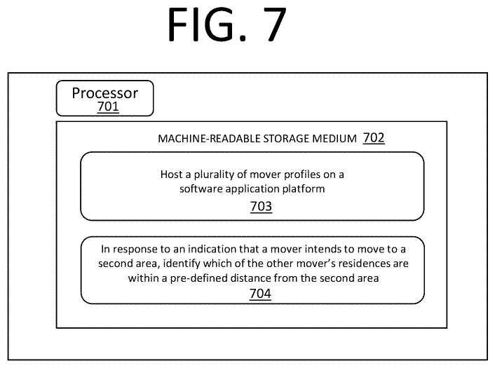

FIG. 7 is an illustration of a computing system 700 according to one embodiment of the present disclosure. Computing system 700 may be used to integrate movers into a social community in a new area. Computing system 700 may include a non-transitory computer readable medium 702 that includes computer executable instructions 703-704 stored thereon that, when executed by one or more processing units 701 (one processor shown), causes the one or more processing units 701 to facilitate a moving process.

Computer executable instructions 703 include instructions to host a plurality of mover profiles on a software application platform. Computer executable instructions 704 include instructions to identify which of the other mover residences are within a pre-defined distance from a second area in response to an indication that a mover intends to move to the second area. In some embodiments, each mover profile includes the mover's marital status, personal interests, number of children, and/or housing attributes.

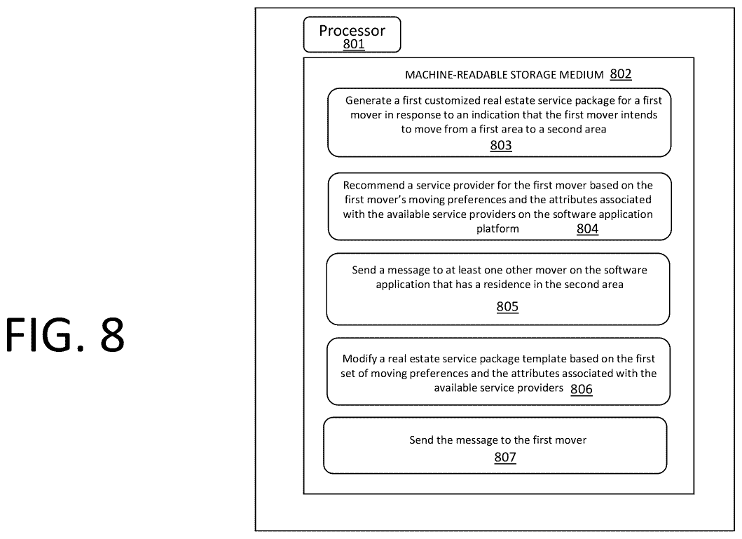

FIG. 8 is an illustration of a computing system 800 according to one embodiment of the present disclosure. Computing system 800 may be used to generate real estate service packages. The computing system 800 may include a non-transitory computer readable medium 802 that includes computer executable instructions 803-807 stored thereon that, when executed by one or more processing units 801 (one processor shown), causes the one or more processing units 801 to facilitate a moving process.

Computer executable instructions 803 include instructions to generate a first customized real estate service package for a first mover in response to an indication that the first mover intends to move from a first area to a second area. Computer executable instruction 804 include instructions to recommend a service provider for the first mover based on the first mover's moving preferences along with the attributes associated with the available serviced providers on the software application platform 804.

Further, computer executable instructions 805 include instructions to send a message to another mover that has a user profile on the software application platform that has a residence. Computer executable instructions 806 includes instructions to modify a real estate service package template based on the first set of moving preferences and the attributes associated with the available service providers. Lastly, computer executable instructions 807 to send the message to the first mover.

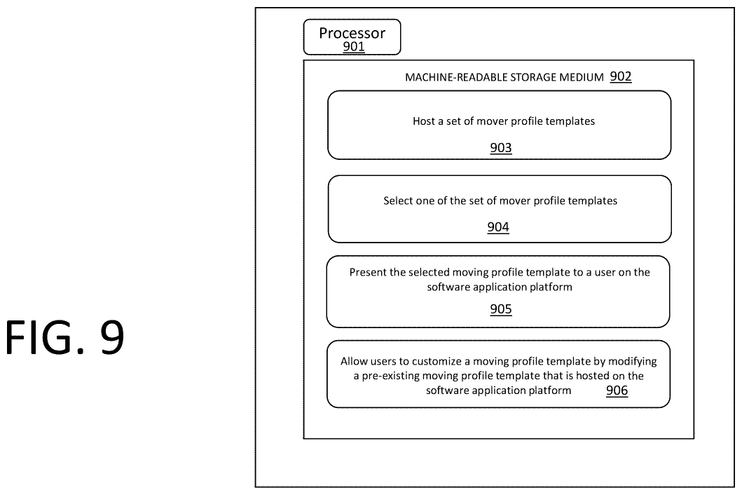

FIG. 9 is an illustration of a computing system 900 according to one embodiment of the present disclosure. Computing system 900 may be used to help integrate movers into a social network in a new location. The computing system 900 may include a non-transitory computer readable medium 902 that includes computer executable instructions 903-906 stored thereon that, when executed by one or more processing units 901 (one processor shown), causes the one or more processing units 901 to facilitate a moving process.

Computer executable instructions 903 include instructions to host a set of mover profile templates. Computer executable instructions 904 include instructions to select one of the set of mover profile templates. Computer executable instructions 905 include instructions to present the selected moving profile template to a user on the software application platform. Lastly, computer executable instructions 906 include instructions to allow users to customize a moving profile template. A moving profile template may be customized by modifying a pre-existing moving profile template that is hosted on the software application platform.

In some implementations, a second set of movers on the software application platform have mover profiles that are within one degree of separation from a first set of movers on the software application platform.

The service providers may be any of a real estate agent, real estate broker, moving service, storage company, lawn maintenance service, etcetera. However, the present disclosure is not limited thereto. The first customized real estate service package may be included in the first mover's profile. For example, the second set of movers may include spouses or other family members of the first set of users.

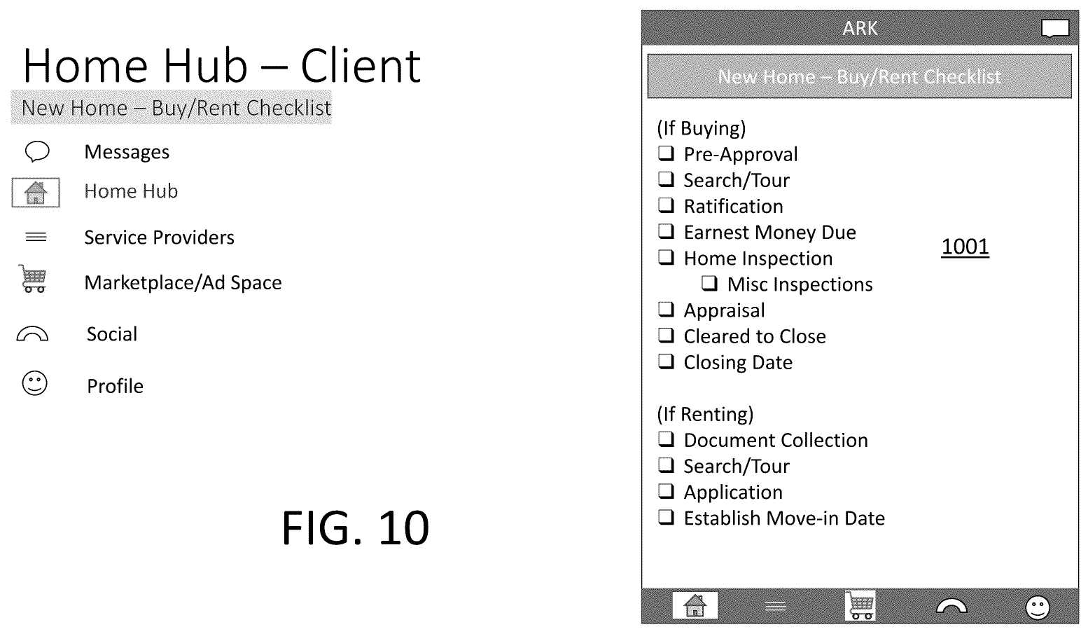

FIG. 10 illustrates a client checklist 1001 for purchasing or renting a home according to one embodiment of the present disclosure. The checklist 1001 can be used by users on the software application platform when purchasing or renting a home. For example, a mover can make selections on the checklist 1001 and the data (e.g., selections) can be sent or retrieved to third party users on the software application platform. For example, the movers' selections on the checklist 1001 may be sent to or retrieved by third party realtors or lenders that have profiles on the software application platform.

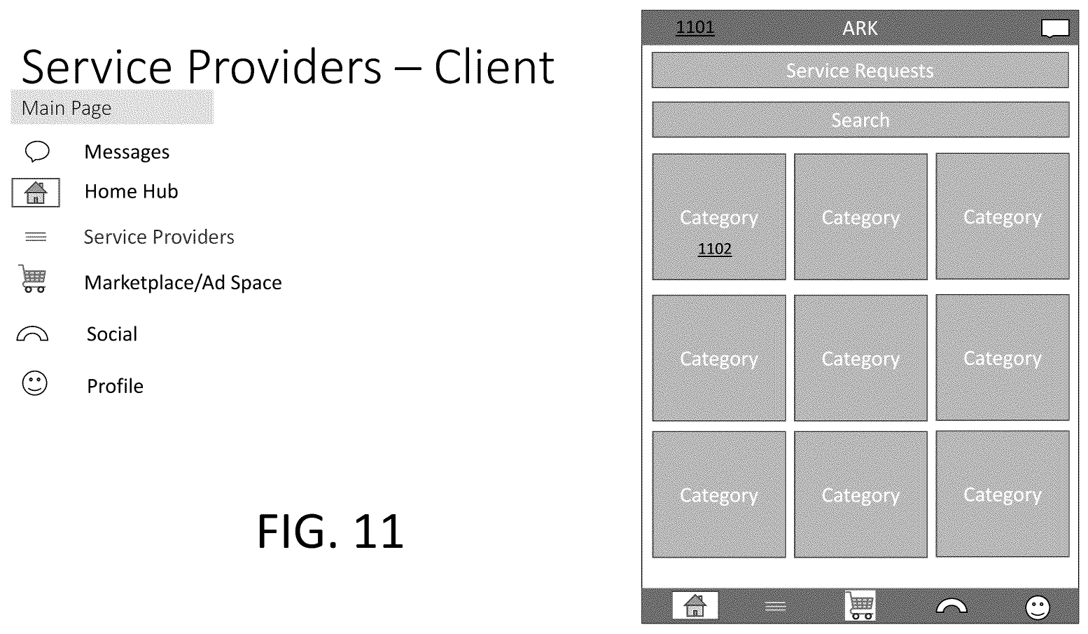

FIG. 11 illustrates a manner for users within a software application platform to make service request according to one embodiment of the present disclosure. FIG. 11 illustrates a client interface 1101, accessible to users on the software application platform, which may feature service categories to aid the client in their quest for services.

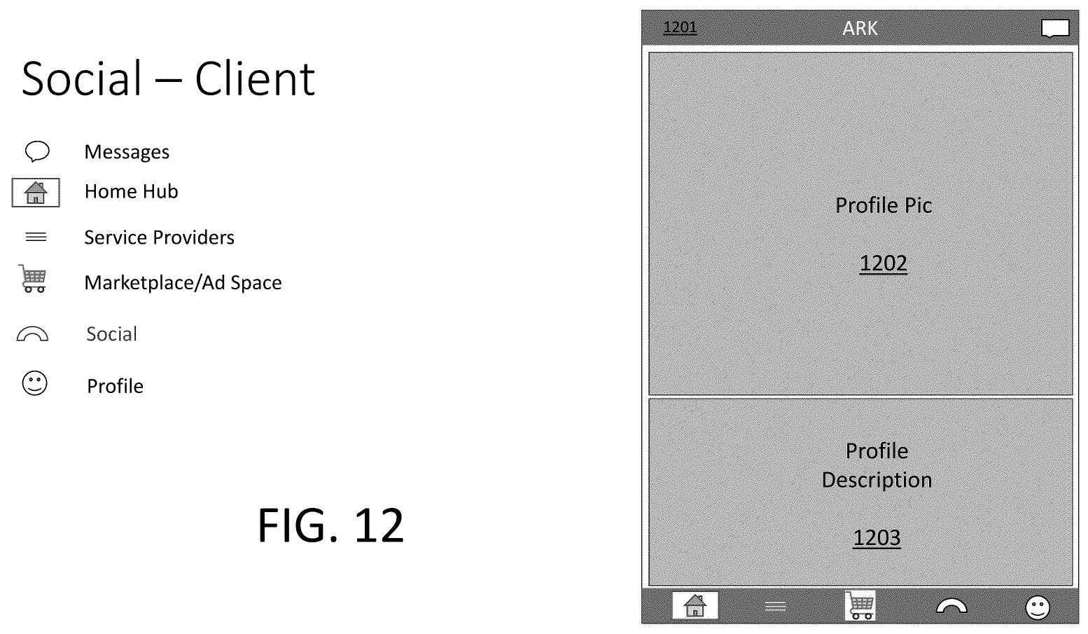

FIG. 12 illustrates a manner of users within a software application platform to send friend requests to other users on the platform according to one embodiment of the present disclosure. FIG. 12 illustrates a user interface 1200 which are accessible to users on the software application platform. In the embodiment shown in FIG. 12, the profiles of other users on the software application platform includes a profile pic 1202 and profile description 1203. The user may indicate a desire to “friend” other users via a double tap, add (friend) button selection, or other suitable manner.

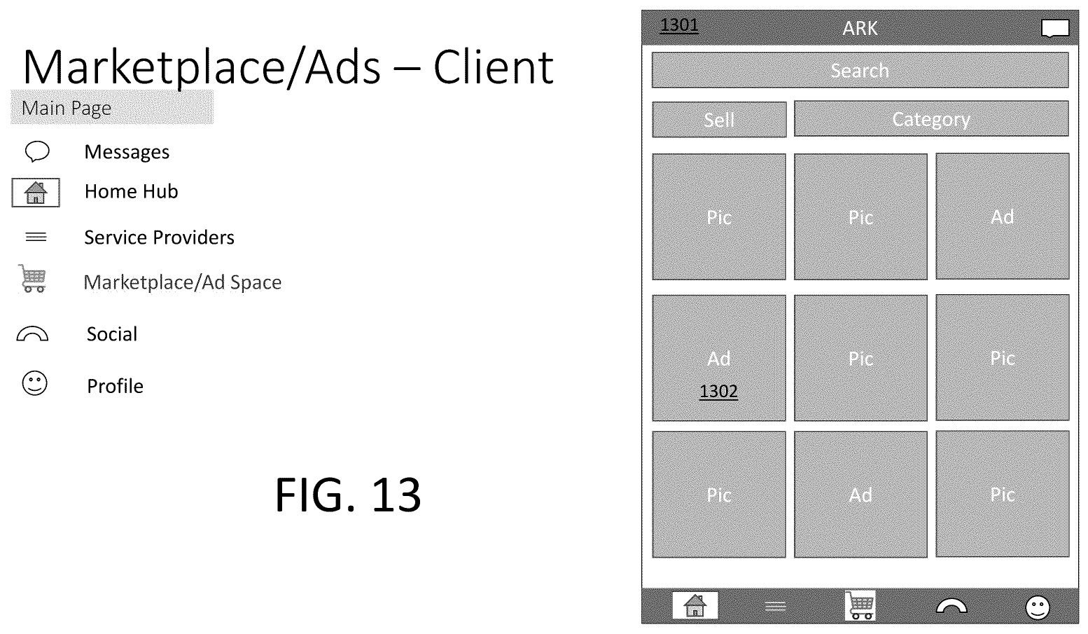

FIG. 13 illustrates a manner of users within a software application platform to create and manage business advertisements according to one embodiment of the present disclosure. The advertisements can be for services offered on the software application platform. For example, a lender with a user profile on the software application platform can create and post advertisements 1302 to be seen by other users (e.g., movers, lenders, etc.) on the software application platform The software application platform can be enabled to send advertisements to other users on the platform on a periodic basis which can be set by a user. In other implementations, rules set forth in the software application platform that determines the frequency that the advertisements are sent to other users on the platform. In addition, rules can be applied to software application platform to determine which users on the platform receive the advertisements. As such, the software application platform may be configured to send advertisements to users based on user classifications. For instance, the software application platform may be configured such that a lender on the platform can send advertisements to only users whose profile indicate that they are moving and seek to purchase a new home.

Further, the software application platform may be configured to automatically dispatch to users on the software application platform upon the occurrence of an event. For example, when a new client profile is created on the software application platform, an advertisement may be dispatched to new users on the software application platform shortly after (e.g., based on a pre-defined time period) their user profiles are created.

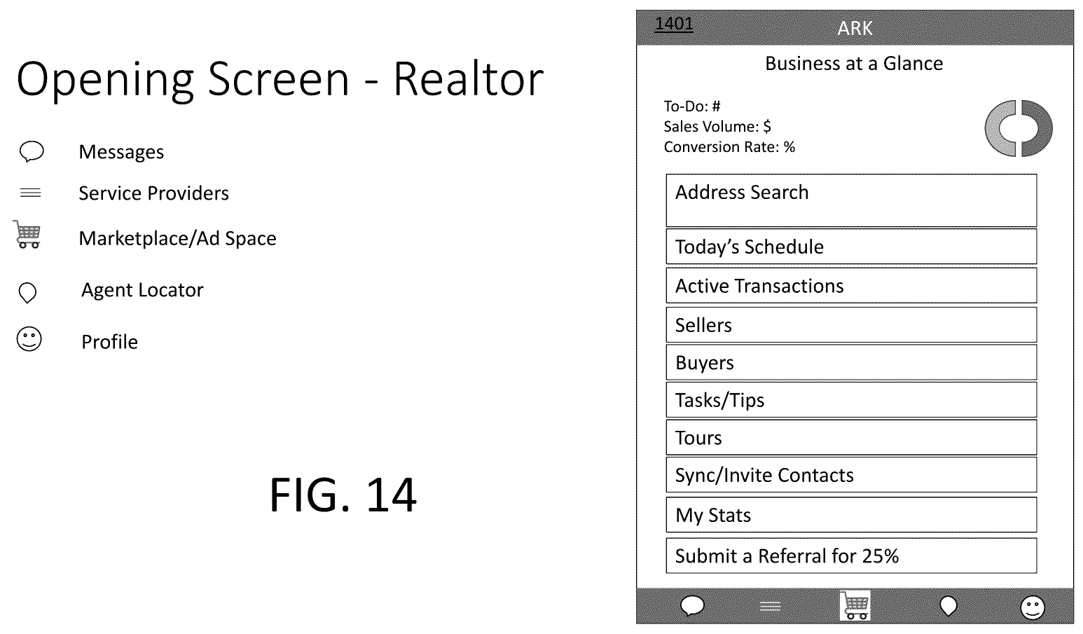

FIG. 14 illustrates a manner for users within a software application platform to track and manage real estate transactions according to one embodiment of the present disclosure. In one embodiment of the present disclosure, user interface 1401 may be used by a realtor to manage tasks, evaluate performance, (e.g., sales volume), etcetera.

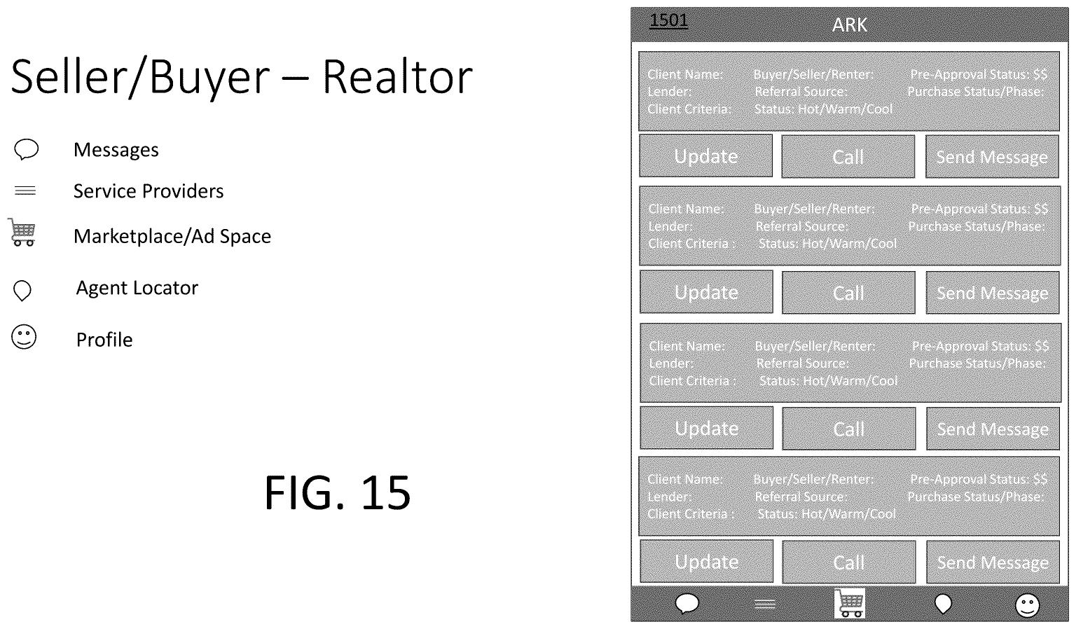

FIG. 15 illustrates a manner for users within a software application platform to communicate with clients according to one embodiment of the present disclosure. For example, user interface 1501 may be used by a realtor to manage communications and other information relevant to client leads. For instance, realtors with access to the software application platform described herein can track pre-approval or to statuses of client leads on the platform.

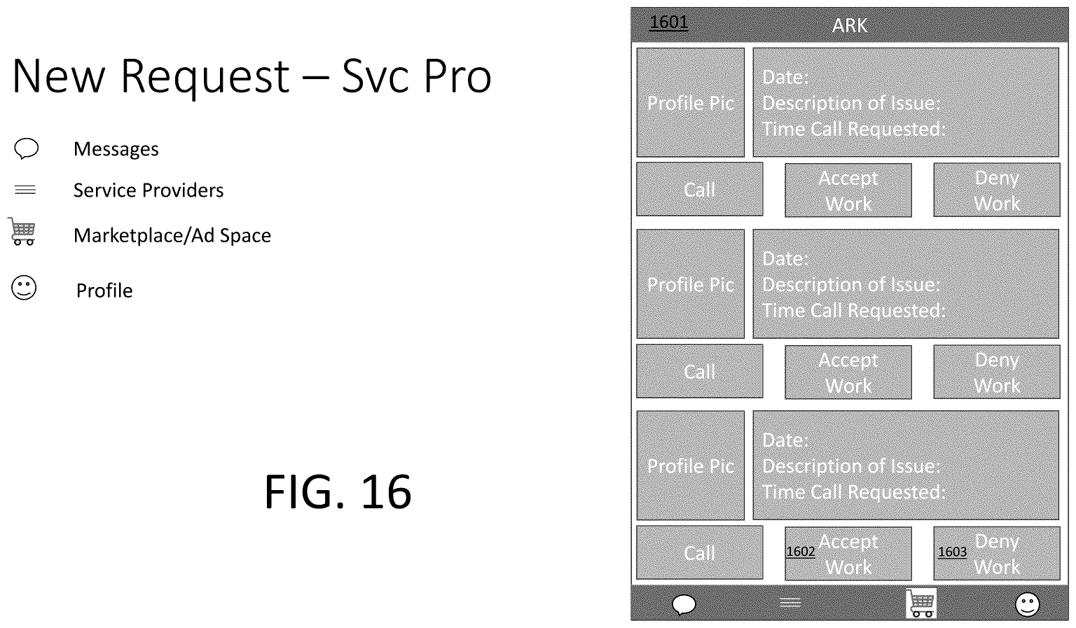

FIG. 16 illustrates a manner for users within a software application to manage new service requests according to one embodiment of the present disclosure. As shown, the user interface 1601 includes accept and deny buttons 1602, 1603. User interface 1601 may also include a profile pic and details regarding a requested service.

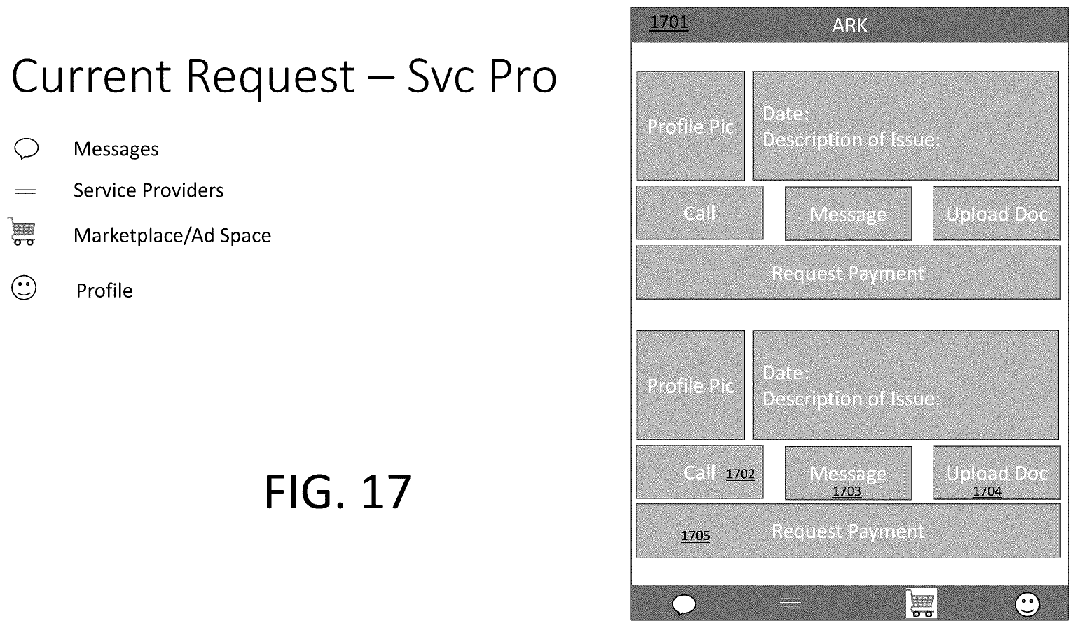

FIG. 17 illustrates a user interface for managing present service requests according to one or more embodiments of the present disclosure. As shown, the user interface 1701 includes call button 1702, message button 1703, service request button 1704, or request payment button 1705. The user interface 1701 may also include a profile pic 1706 and a description of the service request 1707.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present disclosure. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present disclosure have been described. It will be understood that the descriptions of some embodiments of the present disclosure do not limit the various alternative, modified, and equivalent embodiments which may be included within the spirit and scope of the present disclosure as defined by the appended claims. Furthermore, in the detailed description above, numerous specific details are set forth to provide an understanding of various embodiments of the present disclosure. However, some embodiments of the present disclosure may be practiced without these specific details. In other instances, well known methods, procedures, and components have not been described in detail so as not to unnecessarily obscure aspects of the present embodiments.

1. A computing device comprising a non-transitory machine readable storage medium containing instructions that, when executed, causes the computing device to:
retrieve a first mover profile associated with a first mover on a software application platform in response to an indication made on the software application platform that the first mover intends to move residences,
wherein the first mover profile includes a first set of moving preferences;
recommend on the software application platform at least one service provider having at least one service attribute based on the first set of preferences and the at least one attribute, wherein the at least one service attribute associated with the service provider include user ratings and reviews;
associate the retrieved first mover profile with a lead source phase on the software application platform, wherein the lead source phase comprises:
a broker phase configured to forward the first mover profile to a broker profile, enable communication between the user of the first mover profile and the user of the broker profile, and enable assignment of a real estate agent profile for the first mover profile,
an agent phase configured to enable communication between the user of the first mover profile and the user of the assigned real estate agent profile, and
a community phase configured to integrates the first mover profile to social groups and communities on the software application platform based on the first set of preferences;
and
display a client checklist on the software application platform for the first mover to make selections according to the set of preferences and provide the data of the selections on the checklist to third party users.

2. The computing device comprising a non-transitory machine readable storage medium containing instructions of claim 1, wherein the first set of preferences includes at least one of a set of housing attributes, a set of housing furnishings, a set of neighborhood demographics, school ratings, and listing of social events.

3. The computing device comprising a non-transitory machine readable storage medium containing instructions of claim 1, further comprising instructions to store a plurality of mover profiles associated with a plurality of movers on the software application platform and a plurality of service provider profiles associated with a plurality of service providers on the software application platform; and
host a set of mover profile templates and select a mover profile template for the first mover profile based on the set of preferences.

4. The computing device comprising a non-transitory machine readable storage medium containing instructions of claim 3, wherein the plurality of service providers include realtors, lenders, moving companies, and lawn maintenance services.

5. (canceled)

6. The computing device comprising a non-transitory machine readable storage medium containing instructions of claim 1, further comprising instructions to display a profile on the software application platform associated with the at least one selected service provider to the first mover.

7. The computing device comprising a non-transitory machine readable storage medium containing instructions of claim 1, wherein the first mover profile includes the first set of moving preferences based on a second set of moving preferences associated with the first mover during at least one previous residential move.

8. The computing device comprising a non-transitory machine readable storage medium containing instructions of claim 1, further comprising instructions to prompt the first mover to submit moving preferences.

9. The computing device comprising a non-transitory machine readable storage medium containing instructions of claim 1, further comprising instructions to apply a geofence around the first mover's move location within which the at least one service provider is selected.

10.-12. (canceled)

13. A computing device comprising a non-transitory machine readable storage medium containing instructions that, when executed, causes the computing device to:
generate a first customized real estate service package for a first mover in response to an indication that the first mover intends to move from a first area to a second area,
wherein generating the first real estate customized service package includes:
retrieve a first mover profile associated with the first mover in response to the indication made on a software application platform that the first mover intends to move residentials,
wherein the first mover profile includes a first set of moving preferences;
recommend at least one service provider for the first mover based on the first mover's moving preferences and the attributes associated with the available service providers on the software application platform, wherein the attributes associated with the service providers include user ratings and reviews;
associate the retrieved first mover profile with a lead source phase on the software application platform, wherein the lead source phase comprises:
a broker phase configured to forward the first mover profile to a broker profile, enable communication between the user of the first mover profile and the user of the broker profile, and enable assignment of a real estate agent profile for the first mover profile,
an agent phase configured to enable communication between the user of the first mover profile and the user of the assigned real estate agent profile, and
a community phase configured to integrates the first mover profile to social groups and communities on the software application platform based on the first set of preferences;
display a client checklist on the software application platform for the first mover to make selections according to the set of preferences and provide the data of the selections on the checklist to third party users; and
send a message to at least one other mover on the software application platform which is part of the same social group or community and that has a residence in the second area.

14. The computing device comprising a non-transitory machine readable storage medium containing instructions of claim 13, further comprising instructions to modify a real estate service package template based on the first set of moving preferences and the attributes associated with the available service providers;
host a set of mover profile templates and select a mover profile template for the first mover profile based on the set of preferences; and
display a profile on the software application platform associated with the at least one service provider to the first mover.

15. The computing device comprising a non-transitory machine readable storage medium containing instructions of claim 13, further comprising instructions to send the message to the first mover and wherein the message facilitates an introduction between the first mover and the at least one other mover that has a residence in the second area.

16. The computing device comprising a non-transitory machine readable storage medium containing instructions of claim 13, wherein a second set of movers on the software application platform have mover profiles within one degree of separation from a first set of movers on the software application platform.

17. The computing device comprising a non-transitory machine readable storage medium containing instructions of claim 13, wherein the number of recommended at least one service provider is limited to a pre-defined threshold.

18. The computing device comprising a non-transitory machine readable storage medium containing instructions of claim 13, wherein the at least one service provider includes a real estate agent, real estate broker, moving service, and storage company.

19. The computing device comprising a non-transitory machine readable storage medium containing instructions of claim 13, wherein the first customized real estate service package is included in the first mover's profile.

20. The computing device comprising a non-transitory machine readable storage medium containing instructions of claim 13, wherein the indication that the first mover intends to move to the second area is facilitated by a user selection within the software application platform.

21. The computing device comprising a non-transitory machine readable storage medium containing instructions of claim 1, further comprising instructions to host a plurality of mover profiles and identify which of other mover residences are within a pre-defined distance from a first mover's move location to integrate the first mover profile to a social group or community integrated by the plurality of mover profiles identified within the pre-defined distance.

22. The computing device comprising a non-transitory machine readable storage medium containing instructions of claim 21, wherein each mover profile includes the mover's marital status, personal interests, number of children, profession and housing attributes.

23. The computing device comprising a non-transitory machine readable storage medium containing instructions of claim 13, further comprising instructions to host a plurality of mover profiles and identify which of other mover residences are within a pre-defined distance from the second area to integrate the first mover profile to a social group or community integrated by the plurality of mover profiles identified within the second area.

24. The computing device comprising a non-transitory machine readable storage medium containing instructions of claim 23, wherein each mover profile includes the mover's marital status, personal interests, number of children, profession and housing attributes.

25. The computing device comprising a non-transitory machine readable storage medium containing instructions of claim 1, further comprising instructions to verify the first mover profile on the software application platform based on linked social media credentials of the first mover.

26. The computing device comprising a non-transitory machine readable storage medium containing instructions of claim 1, further comprising instructions to send advertisements on the software application platform to the first mover based on the first set of preferences and the indication that the first mover intends to move residences.

27. The computing device comprising a non-transitory machine readable storage medium containing instructions of claim 25, further comprising instructions to vet a prospective user which desires to be member on the software application platform via its linked social media credentials.

28. The computing device comprising a non-transitory machine readable storage medium containing instructions of claim 1, further comprising instructions to vet the at least one service provider according to the user ratings and reviews.

29. The computing device comprising a non-transitory machine readable storage medium containing instructions of claim 3, wherein the set of mover profiles templates are tailored to movers with a particular family profile, moving location and marital status.

30. The computing device comprising a non-transitory machine readable storage medium containing instructions of claim 3, wherein the mover profile template of the first mover is selected based on the popularity of the template.

31. The computing device comprising a non-transitory machine readable storage medium containing instructions of claim 3, further comprising instructions to allow users to create a customized mover profile by modifying a pre-existing mover profile template.

32. The computing device comprising a non-transitory machine readable storage medium containing instructions of claim 1, further comprising instructions for the users of the software application platform to track and manage real state transactions, manage tasks or evaluate performance of the at least one service provider.

33. The computing device comprising a non-transitory machine readable storage medium containing instructions of claim 13, further comprising instructions to verify the first mover profile on the software application platform based on linked social media credentials of the first mover.

34. The computing device comprising a non-transitory machine readable storage medium containing instructions of claim 13, further comprising instructions to send advertisements on the software application platform to the first mover based on the first set of preferences and the indication that the first mover intends to move residences.

35. The computing device comprising a non-transitory machine readable storage medium containing instructions of claim 33, further comprising instructions to vet a prospective user which desires to be member on the software application platform via its linked social media credentials.

36. The computing device comprising a non-transitory machine readable storage medium containing instructions of claim 13, further comprising instructions to vet the at least one service provider according to the user ratings and reviews.

37. The computing device comprising a non-transitory machine readable storage medium containing instructions of claim 14, wherein the set of mover profiles templates are tailored to movers with a particular family profile, moving location and marital status.

38. The computing device comprising a non-transitory machine readable storage medium containing instructions of claim 14, wherein the mover profile template of the first mover is selected based on the popularity of the template.

39. The computing device comprising a non-transitory machine readable storage medium containing instructions of claim 14, further comprising instructions to allow users to create a customized mover profile by modifying a pre-existing mover profile template.

40. The computing device comprising a non-transitory machine readable storage medium containing instructions of claim 13, further comprising instructions for the users of the software application platform to track and manage real state transactions, manage tasks or evaluate performance of the at least one service provider.
